(19) United States
(12) Patent Application Publication
(10) Pub. No.: US 2017/0120864 A1
(43) Pub. Date: May 4, 2017

(54) Methods and Systems for Enabling a Vehicle Drive-Away

(71) Applicant: Myine Electronics, Inc., Ferndale, MI (US)

(72) Inventors: Joel J. FISCHER, Royal Oak, MI (US); Justin DICKOW, Royal Oak, MI (US); Corey MAYLONE, Berkley, MI (US); John BYRNE, Detroit, MI (US); Scott SMEREKA, Warren, MI (US); Joey Ray GROVER, Madison Heights, MI (US)

(21) Appl. No.: 14/930,098

(22) Filed: Nov. 2, 2015

(51) Int. Cl. B60R 25/045; B60K 35/00

(52) U.S. Cl. CPC B60R 25/045; B60K 35/00

(57) ABSTRACT

A vehicle computing system includes a processor connected to a transceiver and programmed to prompt an occupant via a user interface to pair a device detected by the transceiver. The processor is further programmed to receive input at the user interface to associate the device with a pre-approval setting for enabling a vehicle start request when the device having the pre-approval setting and a vehicle key are detected by the processor.

### TECHNICAL FIELD

The present disclosure generally relates to vehicle computing systems, and more particularly, to the vehicle computing system managing a vehicle start request.

### BACKGROUND

A vehicle computing system is used to provide several features and functions including remote starting, keyless entry, hands-free calling, navigation information and music to an occupant while traveling to a destination. The vehicle computing system may provide settings to allow configuration of certain vehicle features and functions based on an occupant's preference. The settings may be manually configured once the occupant enters the vehicle. For example, the vehicle computing system may be configured to adjust climate control settings at the vehicle. The climate control settings may be initiated using physically-actuated inputs carried by the vehicle and manipulated by the vehicle occupant.

The vehicle computing system may communicate with an anti-theft system to prevent unauthorized access and drive-away of a vehicle. Unlike the several features and functions that have physically actuated settings, the anti-theft system does not allow for manual configuration based on an occupant's preference. The anti-theft system may provide both a passive (self-activating, for example) or manual set system (a switch, for example). A manually set anti-theft device has an immediate disadvantage because it requires a commitment to arm the device every time the vehicle is left vacant. The passive device may enable automatically, however the anti-theft system is not smart enough to recognize an authorized user. More specifically, the manual and passive anti-theft systems may allow an unauthorized user to access the vehicle if they are in possession of the passive or manual device to disarm the system. The unauthorized user may take a vehicle key and/or key fob to disarm the anti-theft system while enabling a vehicle ignition system. Therefore, the anti-theft system may allow the unauthorized user to enable a drive-away event.

### SUMMARY

In at least one embodiment, a system includes a processor connected to a transceiver and programmed to prompt an occupant via a user interface to pair a device detected by the transceiver. The processor is further programmed to receive input at the user interface to associate the device with a pre-approval setting for enabling a vehicle start request when the device having the pre-approval setting and a vehicle key are detected by the processor.

In at least one embodiment, a driver authorization method uses a vehicle processor to start a powertrain based on a recognized key and a previously paired mobile device. The method includes receiving, via the vehicle processor, a request to start a powertrain based on a key recognized by an ignition system and searching for a previously paired mobile device based on the request to start the powertrain. The method further includes enabling the ignition system if the previously paired mobile device is detected, and immobilizing the ignition system if the previously paired mobile device is associated with a predefined restriction by the vehicle processor.

In at least one embodiment, a computer-program product embodied in a non-transitory computer readable medium having stored instructions for programming a processor, comprises instructions for prompting an occupant via a user interface to pair a mobile device based on a predefined password. The computer-program product includes further instructions for associating the mobile device with a start-approval setting to implement a vehicle start request by enabling an ignition system when a vehicle key and the mobile device having the start-approval setting are detected by the processor.

### BRIEF DESCRIPTION OF THE DRAWINGS

FIG. 1 is a representative topology of a vehicle computing system implementing a user-interactive vehicle information display system according to an embodiment;

FIG. 2 is an illustrative example of the vehicle computing system configured to recognize a mobile device associated with an authorized driver for a drive-away event according to an embodiment;

FIG. 3 is an illustrative example of using a key fob and a recognized mobile device to enable an ignition system according to an embodiment;

FIG. 4 is an illustrative example of the vehicle computing system presenting a configuration screen for driver authorization settings according to an embodiment;

FIG. 5 is a flow chart illustrating an example method of the vehicle computing system communicating with a key and the mobile device to authorize a key-on event at the ignition system according to an embodiment; and

FIG. 6 is a flow chart illustrating an example method of the vehicle computing system receiving a temporary disable request to deactivate a driver authorization system for a predefined amount of time according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

The disclosure relates to a vehicle computing system and method having a configurable vehicle anti-theft feature. The anti-theft system may be configured to prevent the vehicle from enabling a key-on event until an authorized vehicle key (and/or key fob) is present within the vehicle cabin and a recognized mobile device (smartphone, for example) is successfully connected to the system. The vehicle computing system may be configured to lock-out the recognized mobile device at predefined times and/or on predefined days. For example, the vehicle computing system may pair one or more mobile devices associated with at least one predefined user. The vehicle computing system may recognize a mobile device and if the recognized mobile device is associated with a teenage driver, the system may be configured to lock-out the teenage driver from starting the vehicle based on a predefined time, predefined day, and a combination thereof.

In another example, if a mobile device for an authorized vehicle driver is forgotten, lost, stolen, or has run out of battery power, the vehicle computing system may be configured to issue a one-time passcode to turn off the vehicle anti-theft feature for a predefined time before the system is automatically re-enabled. The one-time passcode may be entered at a user interface screen or may be sent directly to the vehicle computing system via a wireless signal.

The vehicle computing system may allow a vehicle owner and/or operator to configure the anti-theft system such that one or more mobile devices may be authorized to enable a drive-away event via a vehicle ignition system. The anti-theft system may allow further restriction settings to be selected and configured for the one or more mobile devices. In response to the vehicle computing system recognizing a mobile device and the vehicle key being present in the vehicle cabin, the system may enable a powertrain start request via the vehicle ignition system.

Embodiments of this disclosure illustrate a mobile device managed by the vehicle computing system as additional anti-theft security verification before allowing a vehicle drive-away event via the key and/or key fob. In general, the key fob, key, and/or mobile device may be designed to allow for transmission of security codes using a secured method of wireless communication including, but not limited to, Bluetooth, radio frequency, near field communication, Bluetooth Low Energy, and a combination thereof. The embodiments of the present disclosure provide a system and method allowing the management of the drive-away event using the mobile device 53 and the vehicle key/key fob in communication with the vehicle computing system.

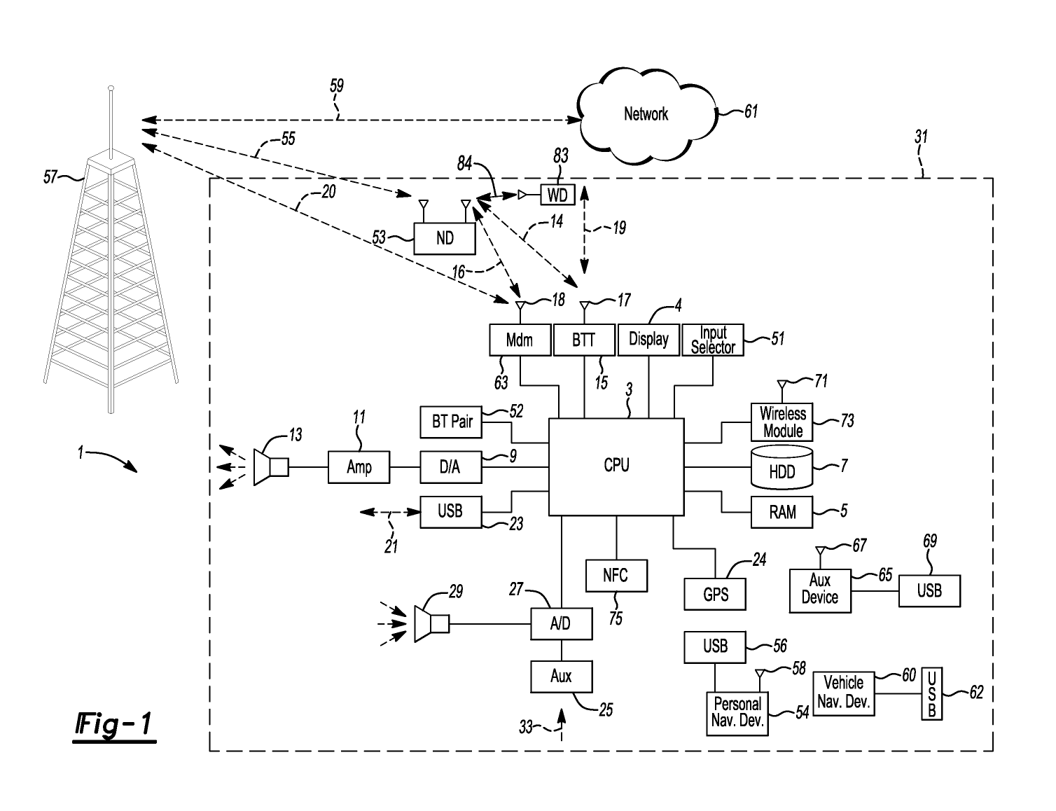

FIG. 1 illustrates an example block topology for the VCS 1 for a vehicle 31. An example of such a VCS 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, or a spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor 3 is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor 3 is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS 1 may use a vehicle network (such as, but not limited to, a CAN bus) to pass data to and from the VCS 1 (or components thereof).

Outputs to the system may include, but are not limited to, a visual display 4 and a speaker 13 or stereo system output. The speaker 13 is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (cell phone, smart phone, PDA, or any other device having wireless remote network connectivity, for example). The nomadic device 53 may then be used to communicate 59 with a network 61 outside the vehicle 31 through, for example, communication 55 with a cellular tower 57. In some embodiments, tower 57 may be a WiFi access point. The nomadic device 53 may also be used to communicate 84 with an accessory device such as a wearable device 83 (smartwatch, smart glasses, etc., for example). The nomadic device 53 may communicate one or more control functions to the wearable device 83. For example, the nomadic device 53 may enable the wearable device 83 to accept a phone call, enable a mobile application, receive notifications, and/or a combination thereof. In another example, the wearable device 83 may transmit vehicle control features/functions to the VCS 1 based on one or more mobile applications executed at the nomadic device 53.

Communication between the nomadic device 53 and the BLUETOOTH transceiver is represented by signal 14. Pairing a nomadic device 53 and the BLUETOOTH transceiver 15 can be instructed through a button 52 or similar input. Accordingly, the CPU 3 is instructed so that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having an antenna 18 in order to communicate 16 data between CPU 3 and network 61 over the voice band. The nomadic device 53 may then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

For example, the VCS 1 may include hardware and software to recognize a vehicle key associated with the vehicle and an authorized nomadic device 53 (mobile device, that is) before enabling the key-on event. More specifically, the VCS 1 may prevent a powertrain start request until the system recognizes both the vehicle key and a previously paired mobile device. The VCS 1 may be configured to manage authorization of a vehicle operator via the vehicle operator's mobile device. The VCS 1 may allow the management for the authorization of one or more mobile devices to enable the key-on event via a user interface display 4. In another example, the VCS 1 may allow one or more restriction settings to be associated with the one or more mobile devices via the user interface display 4.

In one illustrative embodiment, the processor 3 is provided with an operating system including an application program interface (API) to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the nomadic device 53 includes a modem for voice band or broadband data communication. In the data-over-voice embodiment, a technique known as frequency division multiplexing may be implemented when the owner of the nomadic device 53 can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device 53, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device 53 via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 3 could be in communication with a variety of other auxiliary devices 65. These devices can be connected through a wireless 67 or wired 69 connections. Auxiliary device 65 may include, but are not limited to, personal media players, wireless health devices, portable computers, and the like.

Also, or alternatively, the CPU 3 could be connected to a vehicle based wireless router 73, using for example a WiFi (IEEE 803.11) 71 transceiver. This could allow the CPU 3 to connect to remote networks in range of the local router 73.

In addition to having representative processes executed by a VCS 1 located in a vehicle, in certain embodiments, the processes may be executed by a computing system in communication with a vehicle computing system. Such a system may include, but is not limited to, a mobile device (a mobile phone, a smartphone, the nomadic device 53, etc., for example) or a remote computing system (a server, for example) connected through the mobile device 53. Collectively, such systems may be referred to as vehicle associated computing systems (VACS). In certain embodiments particular components of the VACS may perform particular portions of a process depending on the particular implementation of the system. By way of example and not limitation, if a process includes sending or receiving information with a paired mobile device 53, then it is likely that the mobile device is not performing the process, since the mobile device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the processes.

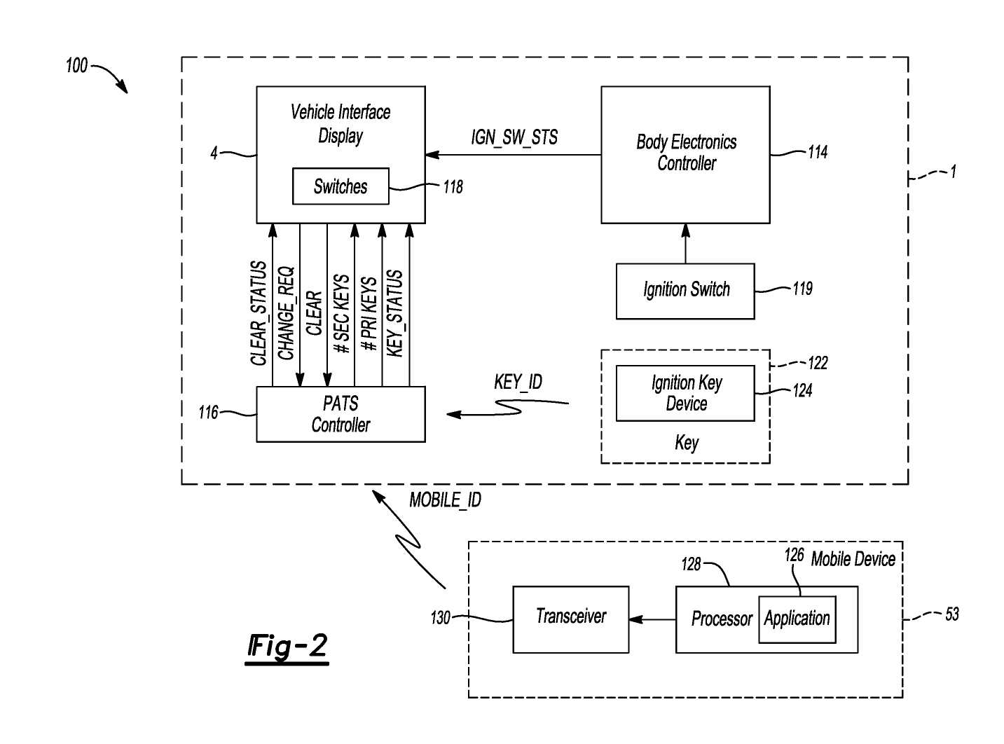

FIG. 2 is an illustrative example of the VCS 1 configured to recognize a mobile device 53 associated with an authorized driver for a drive-away event according to an embodiment. The VCS 1 is in communication with a key 122 and the mobile device 53 so that the system may manage a vehicle drive-away request for one or more drivers of the vehicle. The key 122 may include a mechanical blade having an integrated key fob, a key fob, and/or a combination thereof The VCS 1 may include, but is not limited to, the vehicle interface display 4, a body electronics controller 114, and a passive anti-theft security (PATS) controller 116. The vehicle interface display 4 may be implemented as a message center on an instrument cluster or as a touch screen monitor such that each device is generally configured to present text, menu options, status or other such inquiries to the driver in a visual format. A driver may scroll through the various fields of text and select menu options via at least one switch 118 positioned about the interface display 4. The at least one switch 118 may be remotely positioned from the interface display 4 or positioned directly on the interface display 4. The vehicle interface display 4 may be any such device that is generally situated to provide information and receive feedback to/from a vehicle occupant. The at least one switch 118 may be in the form of voice commands, touch screen, and/or other such external devices (phones, computers, etc., for example) that are generally configured to communicate with the VCS 1 of the vehicle.

The interface display 4, the PATS controller 116, and the body electronics controller 114 may communicate with each other via a multiplexed data link communication bus (or multiplexed bus). The multiplexed bus may be implemented as a High/Medium Speed Controller Area Network (CAN) bus, a Local Interconnect Network (LIN), or any such suitable data link communication bus generally situated to facilitate data transfer between controllers (or modules) in the vehicle.

The body electronics controller 114 generally controls a portion or all of the electrical content in an interior section of the vehicle. In one example, the body electronics controller 114 may be a smart power distribution junction box (SPDJB) controller. The SPDJB controller may include a plurality of fuses, relays, and various micro-controllers for performing any number of functions related to the operation of interior and/or exterior electrically based vehicle functionality. Such functions may include but are not limited to electronic unlocking/locking (via interior door lock/unlock switches), remote keyless entry operation, vehicle lighting (interior and/or exterior), electronic power windows, and/or key ignition status (e.g., Off, Run, Start, Accessory (ACCY)).

An ignition switch 119 may be operably coupled to the body electronics controller 114. The body electronics controller 114 may receive hardwired signals indicative of the position of the ignition switch and transmit multiplexed messages on the multiplexed bus that are indicative of the position of the ignition switch. For example, the body electronics controller 114 may transmit a signal IGN_SW_STS (whether the ignition is in the OFF, Run, Start, or Accessory positions, for example) over the multiplexed bus to the vehicle interface display 4. The signal IGN_SW_STS generally corresponds to the position of the ignition switch (Off, Run, Start, or Accessory positions, for example).

The ignition switch 119 may receive one or more keys to start the vehicle. Each key 122 includes an ignition key device 124 embedded therein for communicating with the vehicle. The ignition key device 124 comprises a transponder (not shown). The transponder includes an integrated circuit and an antenna. The transponder is adapted to transmit a signal KEY_ID in the form of a radio frequency (RF) signal to the PATS controller 116. The signal KEY_ID generally comprises RF data that corresponds to a manufacturer code, a corresponding key serial number and encrypted data. The key serial number and the encrypted data are used to authorize a powertrain controller to start the vehicle in the event the encrypted data corresponds to predetermined encrypted data stored in a look up table (LUT) of the PATS controller 116.

In one example, the PATS controller 116 may use the key number and/or the encrypted data transmitted on the signal KEY_ID to determine if the key is a primary key or a secondary key. In general, the driver who holds the primary key is presumed to be a primary driver (the vehicle owner, the authorized system manager, etc., for example). The driver who holds the secondary key is presumed to be a secondary driver. The secondary driver usually has less control to configure one or more system settings. For example, the secondary driver may not have access to configure the driver authority settings for management of a drive-away event via a recognized mobile device. The one or more keys 122 may be configured as a primary or secondary key via the vehicle interface display 4. The manufacturer code generally corresponds to who the manufacturer of the vehicle is. For example, the manufacturer code may correspond to Ford Motor Company. Such a code prevents the user (or technician) from mistakenly configuring a key with a manufacturer code of another vehicle manufacturer to a Ford vehicle. An example of a LUT that may be stored in the PATS controller 116 is shown in TABLE 1 directly below.

TABLE 1

| KEY SERIAL # | MAN. CODE | ENCRYPTED DATA | TYPE |
|---|---|---|---|
| 1xxA | Ford | #$#$#$#$#$#$#$# | Primary |
| 2xxB | Ford | #######$$$$$$$$ | Secondary |
| 3xxC | Ford | $#$#$#$#$#$#$#$ | Secondary |
| NnnN | Ford | $$$$$$$######## | Primary |

The LUT may include any number of keys to begin the drive-away request to start the vehicle, the PATS controller 116 decodes the key serial number, the manufacturing code, and corresponding encrypted data received on the signal KEY_ID and compares such data to the key serial number and the encrypted data in the LUT to determine whether such data matches prior to starting the vehicle for anti-theft purposes. In the event the data matches, the VCS 1 may being to search for a mobile device 53 before authorizing the powertrain start request. If the data from the key 122 is verified and the mobile device 53 is recognized as an authorized user, the powertrain controller operably coupled to the PATS controller 116 receives an authorization signal to allow the vehicle to start the powertrain.

The mobile device 53 may include hardware and software to communicate with the VCS 1. The mobile device 53 may include, but is not limited to, a cellular phone, tablet, and/or personal computer. The VCS 1 may recognize a paired mobile device to authorize a powertrain start when the vehicle key is present. The mobile device may be recognized by the VCS 1 as having one or more predefined restrictions. For example, the VCS 1 may allow a vehicle owner and/or authorized system manager to associate one or more predefined restrictions with the mobile device 53 using a software application executed on hardware of the VCS 1. An example of a LUT that may be stored in the VCS 1 is shown in TABLE 2 directly below.

TABLE 2

| MOBILE DEVICE | ASSOCIATED | PAIRED MOBILE |
|---|---|---|
| SERIAL # | USER | DEVICE TYPE |
| 1xxA | STACEE | No Restrictions |
| 2xxB | MATTEO | Predefined Date Restriction |
| 3xxC | ELLA | Predefined Geofence Restriction |
| NnnN | MARCO | Predefined Speed Restriction and |
| | | Time Restriction |

For example, before enabling the hardwired signals indicative of the position of the ignition switch 119, the PATS 116 controller and/or VCS 1 may verify if the mobile device 53 and the vehicle key 122 are authorized and present within the vehicle cabin. The mobile device 53 may include a software application 126 being executed on a mobile device processor 128 and configured to transmit a wireless signal to communicate with the VCS 1 via a transceiver 130. The VCS 1 may recognize the mobile device 53 associated to a user using the transmitted wireless signal as shown above in Table 2. The VCS 1 may recognize the paired mobile device from the wireless signal using one or more wireless communication technologies including, but not limited to Bluetooth, WiFi, cellular, and/or near field communication.

In another alternative example, the mobile device 53 may transmit additional signals (MOBILE_ID signal, for example) directly to the PATS controller 116 using an ignition key application executed a the mobile device processor 128. For example, the hardwired signal indicative of the position of the ignition switch 119 may initiate the VCS 1 to begin searching for the mobile device 53. The mobile device 53 may communicate with the VCS 1 using the ignition key application allowing the VCS 1 to recognize if the mobile device 53 has been paired. The VCS 1 may determine based on the encrypted data received from the mobile device 53, and/or the previous configuration of the paired mobile device at the system, if the mobile device is associated with one or more predefined restriction limits.

To determine driver status, the PATS controller 116 decodes the key number and/or the encrypted data received on the signal KEY_ID and reads the corresponding key status (primary or secondary key, for example) next to the key number and/or the encrypted data as shown in the heading ‘TYPE’ of Table 1, and respectively Table 2, to determine whether the key 122 and mobile device 53 are associated with one or more predefined restrictions. The PATS controller 116 transmits a signal KEY_STATUS to the vehicle interface display 4 to indicate whether the key is present. The PATS controller 116 and/or the vehicle interface display 4 may transmit the signal KEY_STATUS to any controller or module in the electrical system such that the functionality or operation performed by a particular controller (or module) may be selectively controlled based on the key status (and/or the driver status).

The LUT in the PATS controller 116 assigns all of the keys and the associated mobile device as primary keys with no restrictions when the vehicle is manufactured in a default condition. The PATS controller 116 may update the key status for a key number in response to the driver changing the key status for a particular key and/or a mobile device 53 via operations performed between the primary driver and the vehicle interface display 4. In another example, the vehicle interface display 4 may update and change the one or more predefined restrictions for the mobile device 53.

The primary driver may optionally clear all mobile devices 53 that were designated as authorized user via the vehicle interface display 4. In such a case, the primary driver may select the corresponding menus via the vehicle interface display 4 to clear all mobile devices that were programmed as authorized devices to enable a powertrain start when the vehicle key is present. For example, the vehicle interface display 4 transmits a signal CLEAR to control the PATS controller 116 to clear (or change) the authorized mobile devices to enable the drive-away event via the powertrain start. The PATS controller 116 may transmit a signal CLEAR_STATUS to the vehicle interface display 4 to notify the vehicle interface display 4 that the mobile devices programmed as authorized devices to enable the drive-away event have been cleared. The PATS controller 116 transmits signals #PRIKEYS and #SECKEYS to the interface display 4 which are indicative of the number of primary keys in the LUT and the number of secondary keys in the LUT, respectively. The PATS controller 116 transmits the signals #PRIKEYS and #SECKEYS in response to control signals (not shown) by the vehicle interface display 4. It is generally contemplated that the signals KEY_STATUS, #PRIKEYS, and #SECKEYS (as well as the signal CLEAR_STATUS) may be sent as one or more messages over the multiplexed bus to the vehicle interface display 4. For example, the data on the signals KEY_STATUS, #PRIKEYS, #SECKEYS, CLEAR_STATUS may be transmitted as hexadecimal based data within a single message over the multiplexed data bus. Likewise, the vehicle interface display 4 may transmit the data on the signals CHANGE_REQ and CLEAR as hexadecimal based data within a single message over the multiplexed data bus. The PATS controller 116 may be integrated within the vehicle interface display 4 or be implemented as a standalone component or as controller embedded within another controller in the VCS 1.

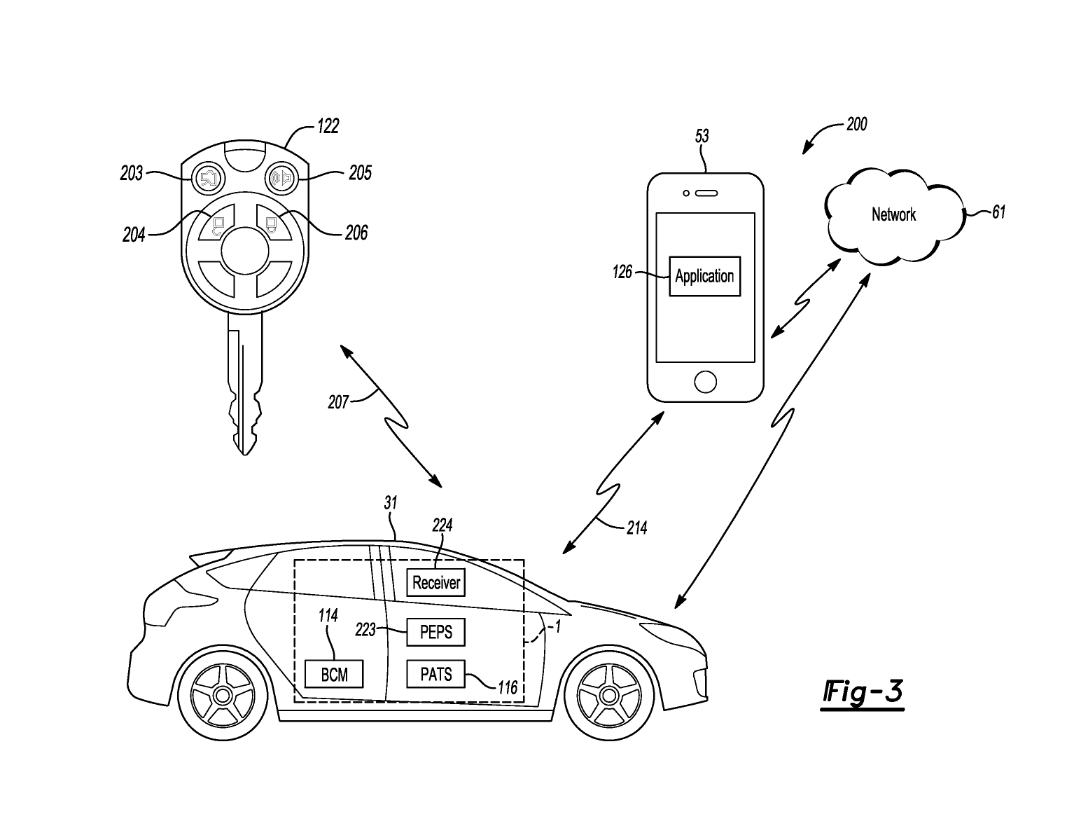

FIG. 3 is an illustrative example of using a key fob 122 and a mobile device 53 to enable an ignition system according to an embodiment. The VCS 1 may include the vehicle interface display 4, a passive entry passive start (PEPS) controller 223, a PATS controller 116, a BCM and a receiver 224. The PEPS controller 223 may be used in place of the PATS controller 116 as illustrated in FIG. 2. While FIG. 3 generally illustrates that the PEPS controller 223 is positioned external to the vehicle interface display 4, other such implementations may include positioning the PEPS controller 223 within the vehicle interface display 4 or within any other such controller in the VCS 1. The particular placement of the PEPS controller 223 may vary based on the desired criteria of a particular implementation.

In general, the PEPS function is a keyless access and start system. The driver may own two or more keys 122 that may be in the form of an electronic transmission device (a key fob, for example). With the PEPS 223 implementation, the user is not required to use a mechanical key blade to open the door of the vehicle or to start the vehicle. Such key 122 may each include a mechanical key to ensure that the driver can access and start the vehicle in the event the keys 122 exhibit low battery power. The keys 122 include an ignition key device for communicating with the PEPS controller 223. The transponder of the key 122 may be adapted to send the key number and encrypted data on the signal KEY_ID as an RF signal to the PEPS controller 223. To gain access or entry into the vehicle with the keys 122 in the PEPS implementation, the driver may need to wake up the PEPS controller 223 to establish bi-directional communication between the keys 122 or mobile device 53 and the PEPS controller 223. In one example, such a wake up may occur by requiring the driver to touch and/or pull the door handle of the vehicle 31. In response to the door handle being toggled or touched, the PEPS controller 223 may wake up and transmit RF based signals to the keys 122 or mobile device 53. The PEPS controller 223 and the keys 122 may undergo a series of communications back and forth to each other (handshaking, for example) for vehicle access authentication purposes. The PEPS controller 223 may unlock the doors in response to a successful completion of the handshaking process. In response to the completion of the handshaking process between the PEPS controller 223 and key 122, the VCS 1 may begin to search for a previously paired mobile device 53. Once the driver is in the vehicle and the mobile device 53 is recognized by the VCS 1 as a previously paired device having no restrictions, the driver may simply press a button positioned on an instrument panel to start the vehicle 31 based on the authorized vehicle key 122 and mobile device 53.

Prior to starting the vehicle, the key and mobile device serial numbers and/or the encrypted data are compared to known key/mobile numbers and/or encrypted data in a look up table (a PEPS look up table, for example) in a manner similar to that described in connection with FIG. 2. The manufacturing code is also checked to ensure the key 122 is used for a particular manufacturer of the vehicle. The PEPS LUT may be similar to the PATS LUT as shown in Table 1. As noted above, additional operations are performed as exhibited with the handshaking exercise in addition to matching the data received on the signal KEY_ID with the data in the LUT (e.g., key serial number and encryption data) to ensure that the user is properly authorized to enter the vehicle and to start the vehicle with the PEPS implementation. As noted above in connection with FIG. 2, all of the keys 122 and paired mobile devices 53 are generally assigned a default status. Such a condition may be reflected under the ‘TYPE’ heading as shown in Table 1 and Table 2. The status of the key 122 may change from primary to secondary in response to the user programming a particular key via the vehicle interface display 4. As further noted above, the PEPS controller 223 ascertains the key status (or driver status) of the key 122 and mobile device 53 (whether primary or secondary, and having a predefined restriction, for example) by decoding the key 122 and mobile device 53 number and/or encrypted data received on the signal KEY_ID and MOBILE_ID, respectively, and looking up to verify if the associated mobile device 53 is authorized to initiate a vehicle start request. The PEPS controller 223 is configured to transmit the signal KEY_STATUS on the multiplexed bus to the vehicle interface display 4 based on the KEY_ID and MOBILE_ID. The PEPS controller 223 and/or the vehicle interface display 4 may transmit the signal KEY_STATUS to any controller or module in the VCS 1 so that the functionality or operation performed by a particular controller (or module) may be selectively controlled based on the driver status.

The vehicle key 122 may include at least an integrated circuit configured to transmit one or more functions to the VCS 1. The one or more functions transmitted to a VCS 1 may include, but is not limited to, commanding the vehicle 31 to unlock 204 its doors, to lock 206 its doors, to open the trunk 203, and/or to sound a vehicle alarm 205. A combination of and/or sequential selection of the commanding vehicle function inputs on the vehicle key 122 may allow for additional functions. For example, if a user presses the unlock 204 door input on the key the driver door may unlock, and if the user presses the unlock 204 door input twice, all the doors on the vehicle may unlock. Another example of a user to combine the key fob inputs to achieve additional commanding vehicle functions includes, but is not limited to, the use of selecting to press the lock 206 doors input twice within a predetermined amount of time to audible hear verification that the doors on the vehicle 31 are locked.

The vehicle key 122 may include an ignition key device embedded therein for communicating with the vehicle 31. The ignition key device comprises a transponder. The transponder may include an integrated circuit and an antenna. The transponder is adapted to transmit a signal in the form of a radio frequency (RF) signal to a (PATS) controller 116 with the use of a signal receiver 224 in the vehicle 31. The PATS controller 116 may communicate with the VCS 1 and/or body control module (BCM) 114 via a multiplexed data link communication bus (or multiplexed bus). The multiplexed bus may be implemented as a High/Medium Speed Controller Area Network (CAN) bus, a Local Interconnect Network (LIN), or any such suitable data link communication bus generally situated to facilitate data transfer between controllers (or modules) in the vehicle 31.

The signal 207 being transmitted from the key transponder generally comprises RF data that corresponds to a manufacturer code, a corresponding key serial number and encrypted data. The key serial number and the encrypted data are used to authorize the VCS 1 to initiate the vehicle to begin looking for a mobile device 53 in the event the encrypted data corresponds to predetermined encrypted data stored in a look up table of the PATS 116 controller. The PATS 116 controller may use the key number and/or the encrypted data transmitted from the key fob security code signal to determine if the key is from a primary user or a secondary user.

The vehicle key 122 may also be configured to transmit to a PEPS controller 223 allowing for wireless transmission of vehicle control functions without pressing any buttons on the key fob. For example, the PEPS 223 may become initialized by requiring the driver to touch and/or pull the door handle of the vehicle. In response to the door handle being toggled or touched, the PEPS controller 223 may wake up and transmit RF based signals to the keys 122. The PEPS controller 223 and the keys 122 may undergo a series of communication signals 207 back and forth to each other (handshaking, for example) for vehicle access authentication purposes. The PEPS controller 223 may unlock the doors in response to a successful completion of the handshaking process. The VCS 1 may begin to search for a mobile device 53 located near or within the vehicle cabin. Once the mobile device 53 is recognized by the VCS 1, the vehicle occupant may simply press a button positioned on an instrument panel to start the vehicle based on the authorized vehicle key 122 and mobile device 53.

The mobile device 53 may be located in the vehicle cabin and may establish communicating with the VCS 1. The process may require the mobile device 53 to be paired with the VCS 1 before the configuration of one or more restrictions may be associated with the mobile device 53. The VCS 1 requires the vehicle key 122 to initiate the VCS 1 to search and authorize the mobile device 53 in close proximity of the vehicle before enabling the driver-away event.

The mobile device 53 may execute an application 126 on hardware of the device to provide voice commands, touch screen inputs, and/or other mobile device communication functions allowing the user to communicate application data with the VCS 1. For example, if a user is approaching the vehicle, the PEPS 223 may be initialized by a short range communication signal transmitted from the key 122. The mobile device 53 may transmit a signal allowing for the handshaking authorization process to begin with the VCS 1 based on the short range communication signal from the key 122. Once the handshaking between the key 122 and the PEPS 223 is complete, the user may unlock the doors, open the truck, and start the powertrain. The VCS 1 may verify if the recognized mobile device 53 is associated with one or more restrictions before enabling a vehicle drive-away. For example, if the mobile device has a restriction meeting a threshold, the VCS 1 may not all the drive-away event. The VCS 1 may prevent a drive-away event by one or more powertrain controls including, but not limited to, immobilizing the powertrain, preventing the transmission to enter a gear, and/or a combination thereof.

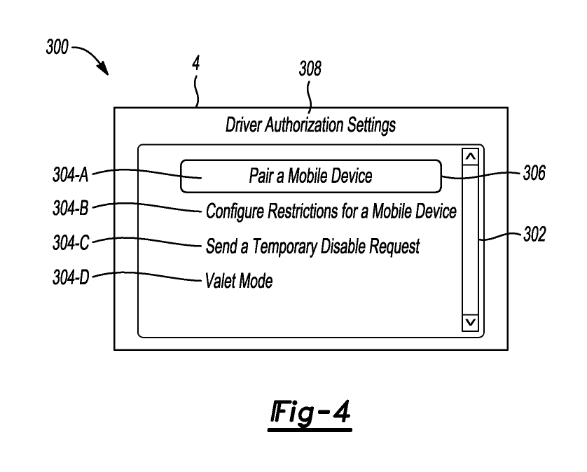

FIG. 4 is an illustrative example of the VCS 1 presenting a configuration option at the display 4 based on a driver authorization system according to an embodiment. The user interface 300 may be presented at the touchscreen display 4 and may include a list control 302 configured to display selectable list entries 304-A through 304-D (collectively 304) of the one or more drive-away features. The VCS 1 may enable the occupant to scroll through each of the selectable list entries 304 based on a request to configure the driver authorization system via the user interface screen 4.

In response to a request to configure the driver authorization system, the VCS 1 may present the selectable list entries 304 at the display 4. The VCS 1 may highlight each of the one or more selectable list entries 304 that may be configured based on the driver authorization setting entry. The user interface 300 may also include a title label 308 to indicate to the user of the user interface 300 the “Driver Authorization Settings” for the driver authorization system.

In response to the one or more settings available for the driver authorization system, the VCS 1 may allow a vehicle owner to provide an additional level of security before the system enables a vehicle drive-away event. The VCS 1 may output the driver authorization settings 308 to the display 4 based on a request to configure the driver authorization system via the occupants input. For example, the VCS 1 may output the driver authorization configuration 308 based on a recognized unpaired mobile device detected by the system. The driver authorization configuration 308 may request a password before outputting the one or more selectable entries 304. The password may include, but is not limited to, a predefined numerical password, a voice password, an alphanumeric password, and/or a question and answer password process. In response to the password being correct, the VCS 1 may output the one or more selectable entries 304. If the password is incorrect, the VCS 1 may not allow access to the one or more selectable entries 304.

In another example, the VCS 1 may only allow the driver authorization settings 308 to be configured when a primary key is recognized by the system. A secondary key may not have access to configure the driver authorization settings 308.

The selectable list entries 304 may include, but are not limited to, an entry 304-A for pairing a mobile device, an entry 304-B for configuring restrictions for a mobile device, an entry 304-C for sending a temporary disable request; and an entry 304-D for selecting valet mode. The list control 302 may operate as a menu, such that an occupant may scroll through the list entries of the list control 302 (using up and down arrow buttons and a select button to invoke the selected menus item 306, for example).

For example, in response to the occupant selecting 306 the pair a mobile device entry 304-A, the VCS 1 may configure the driver authorization system based on the paired mobile device. The driver authorization system may pair one or more mobile devices associated with one or more drivers, and output a paired mobile device list via the display 4 as shown above in Table 2.

The VCS 1 may allow an occupant to restrict the mobile device 53 from enabling a vehicle drive-away event based on the selection of the configure restrictions for a mobile device entry 404-B. For example, the occupant may set one or more predefined restrictions for the paired mobile device as shown above in Table 2. The one or more predefined restrictions include, but are not limited to, date restrictions, time restrictions, geofence restrictions, speed restrictions, radio volume restrictions, and/or a combination thereof.

The occupant may select the send a temporary disable request entry 304-C if the mobile device 53 is not detected by the VCS 1. For example, an occupant may select the system to disable the driver authorization system for a predefined amount of time if the mobile device 53 has been misplaced, is powered off, and/or is not present in the vehicle cabin. In another example, if a secondary key is detected an the mobile device is not recognized, the primary key holder may receive a text message via a mobile device to disable the driver authorization system for a predefined amount of time. The send a temporary disable request entry 304-C may be enabled using a predefined password.

The occupant may select the valet mode entry 304-D based on the vehicle entering a valet parking lot. The valet mode entry 304-D may allow the valet to enable a vehicle drive-away request for a predefined amount of ignition cycles. In one example, the valet mode entry 304-D may only allow the valet to stop and start the vehicle for two ignition cycles without the presence of an authorized mobile device 53. In another example, the valet mode entry 304-D may enable a vehicle drive-away event without the presence of a mobile device for a predefined time period.

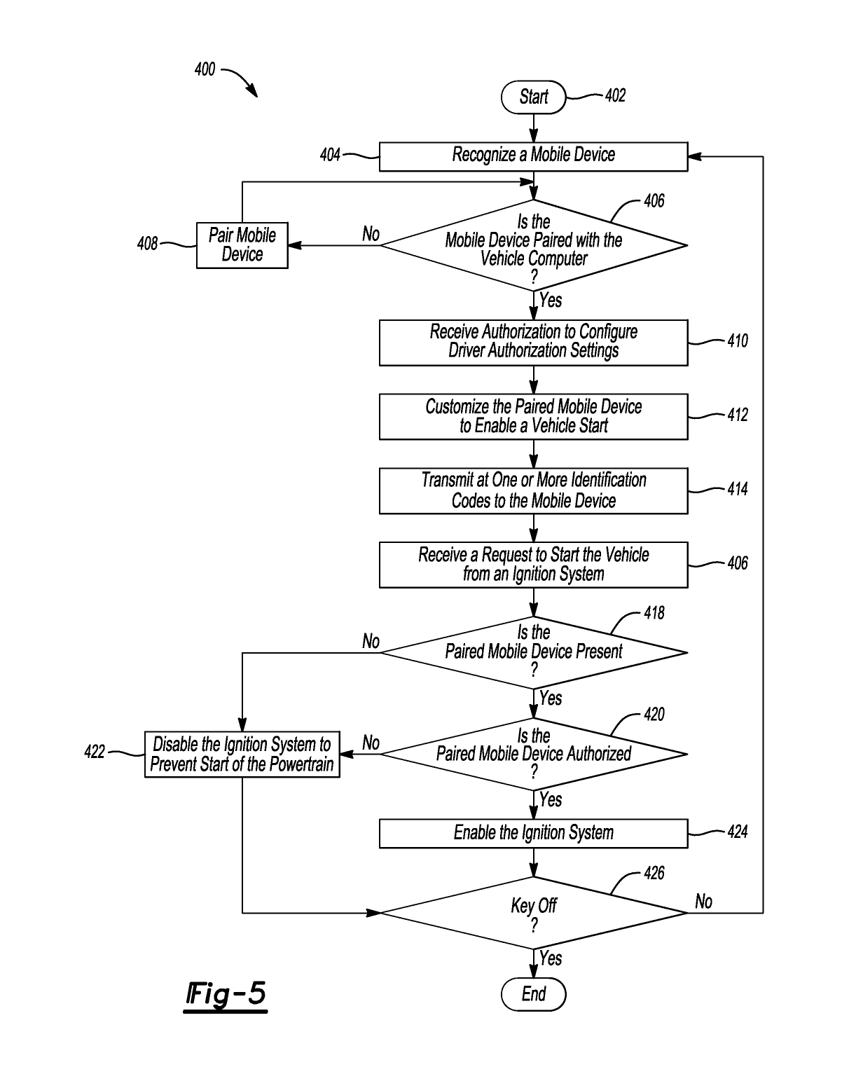

FIG. 5 is a flow chart illustrating an example method 400 of the VCS 1 communicating with a key 122 and the mobile device 53 to authorize a key-on event at the ignition system according to an embodiment. The method 400 may be implemented using software code contained within the VCS 1, remote network 61, mobile device 53, and/or a combination thereof.

Referring again to FIG. 5, the vehicle 31 and its components illustrated in FIG. 1, FIG. 2, FIG. 3, and FIG. 4 are referenced throughout the description of the method 400 to facilitate understanding of various aspects of the present disclosure. The method 400 of managing a vehicle drive-away request (enabling the powertrain system, for example) using the vehicle key 122 and the mobile device 53 may be implemented through a computer algorithm, machine executable code, or software instructions programmed into a suitable programmable logic device(s) of the vehicle, such as the CPU 3, the mobile device control module, another controller in communication with the vehicle computing system, or a combination thereof. Although the various operations shown in the flowchart diagram 400 appear to occur in a chronological sequence, at least some of the operations may occur in a different order, or may be repeatedly performed, and some operations may be performed concurrently or not at all.

In operation 402, the VCS 1 may be initialized and enabled based on the recognition of the vehicle key 122. For example, the VCS 1 may initialize one or more control modules when the ignition system is enabled. The ignition system may allow the VCS 1 to enter an accessory mode; however, the system may not allow a powertrain start request until an authorized mobile device is recognized. In response to the initialization of the VCS 1, the system may search for a mobile device 53.

In operation 404, the VCS 1 may recognize a mobile device 53 using wireless technology. The VCS 1 may determine if the mobile device 53 has been previously paired with the VCS 1 in operation 406. In response to the VCS not recognizing the mobile device 53, the system may execute a pairing process for the mobile device 53 in operation 408. Once the pairing process is complete, the VCS 1 may recognize the mobile device 53.

In operation 410, the VCS 1 may receive authorization to configure one or more settings associated with the paired mobile device 53 for the driver authorization system. The VCS 1 may present the one or more settings if the system receives at least one of a configuration password and/or a primary key is detected. The VCS 1 may output one or more settings to customize the paired mobile device for enabling a vehicle start in operation 412. For example, the VCS 1 may output one or more restriction limits associated with the mobile device 53 so that the system may manage when the occupant may access the vehicle and/or when the occupant may be authorized for a vehicle drive-away event by enabling the powertrain start request. In another example, the VCS 1 may allow the powertrain start request to enable via the vehicle key, however, the vehicle may not be driven-away based on a transmission denying entry of a gear until an authorized mobile device is recognized.

In operation 414, the VCS 1 may transmit one or more identification codes to the mobile device based on the configuration of the one or more restriction limits. The VCS 1 may receive a request to start the vehicle via the ignition system using the vehicle key 122 in operation 416. In response to the request to start the ignition system, the VCS 1 may determine if a mobile device is present in the vehicle cabin in operation 418.

In operation 420, in response to a detected mobile device, the VCS 1 may determine if the mobile device 53 has been previously paired with the system. In response to the mobile device not being previously paired with the VCS 1, the system may disable the ignition system to prevent a vehicle drive-away event (prevent a powertrain start, for example) in operation 422.

In operation 424, in response to the mobile device 53 recognized as a previously paired mobile device having no restrictions, the VCS 1 may enable the ignition system allowing for a vehicle drive-away event. In one example, the previously paired mobile device may have a restriction, however, the ignition system may be enabled if the restriction is within a predefined threshold. More specifically, if the mobile device has a restriction that does not allow the occupant to drive the vehicle at a predefined time, the ignition system may be enabled if the current time is outside the window of the restricted predefined time. The VCS 1 may end the method of the driver authorization system if the mobile device 53 is no longer connected and/or a key-off position of the ignition system is detected in operation 426.

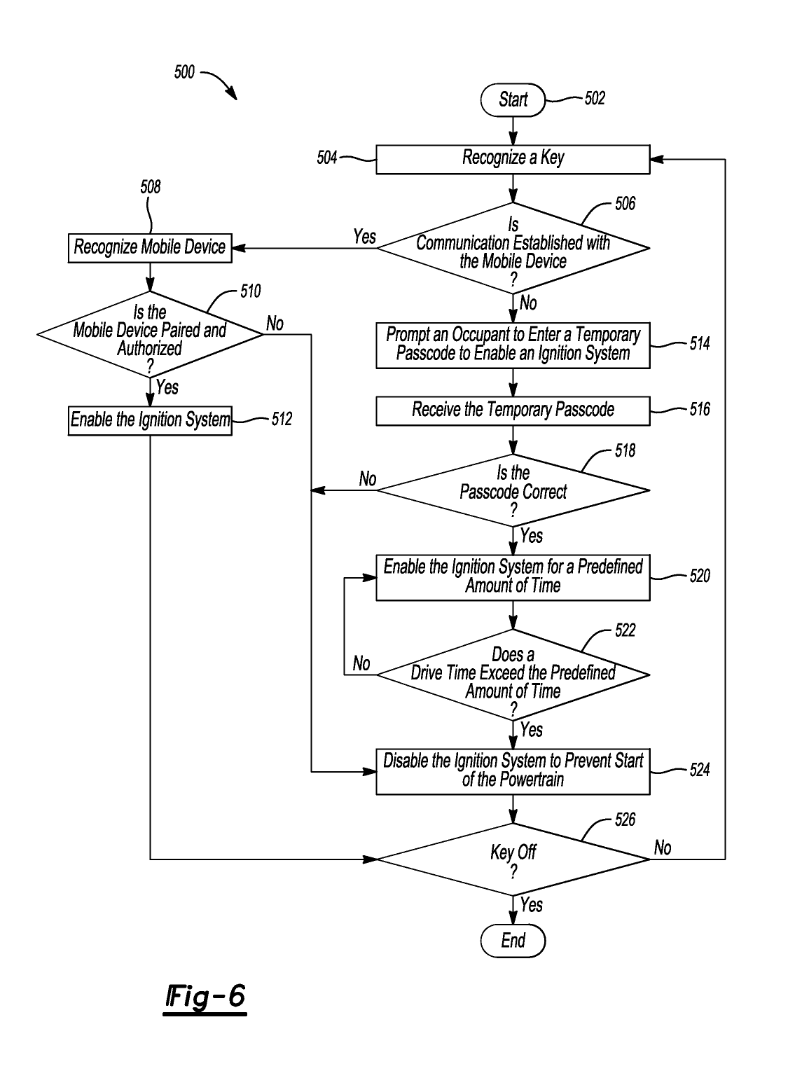

FIG. 6 is a flow chart illustrating an example method 500 of the VCS 1 receiving a temporary disable request to deactivate the driver authorization system for a predefined amount of time according to an embodiment. The VCS 1 may initialize one or more applications based on the detection of a power on request via the ignition system and/or established communication with the vehicle key 122 and/or the mobile device 53 in operation 502.

In operation 504, the VCS 1 may recognize the vehicle key 122 associated with the vehicle. In response to the detected vehicle key, the VCS may determine if communication is established with the mobile device 53 in operation 506.

In operation 508, the VCS 1 may recognize the mobile device requesting communication with the system. The VCS 1 may determine if the detected mobile device is an authorized mobile device 53 in operation 510. In response to the vehicle key 122 being present and the mobile device 53 being an authorized device, the VCS 1 may enable the ignition system for a powertrain start to allow for a vehicle drive-away event in operation 512.

In operation 514, in response to the mobile device not being present and/or not recognized as an authorized device, the VCS 1 may prompt an occupant to enter a temporary passcode to enable an ignition system. The VCS 1 may receive the temporary passcode via the user interface display 4 in operation 516.

In operation 518, the VCS 1 may determine if the received passcode is correct so that the system may enable a vehicle start without the mobile device being present. In response to the passcode being correct, the VCS 1 may enable the ignition system to allow a powertrain start for a predefined amount of time in operation 520.

In operation 522, the VCS 1 may monitor the amount of time the powertrain is enabled to determine if the occupant operates the vehicle for a period exceeding the predefined amount of time. In response to the occupant exceeding the predefined amount of time, the VCS 1 may disable the ignition system to prevent starting of the powertrain system in operation 524. The VCS 1 may end the method of the driver authorization system if the mobile device 53 is no longer connected and/or a key-off position of the ignition system is detected in 526.

While representative embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
a processor configured with a transceiver and programmed to,
in response to detecting a device via the transceiver, prompt an occupant via a user interface to pair the device based on a predefined password; and
receive input at the user interface to associate the device with a pre-approval setting for enabling a vehicle start request when the device having the pre-approval setting and a vehicle key are detected by the processor.

2. The system of claim 1, wherein the processor is further programmed to, in response to at least one of the device having a preconfigured restriction limit meeting a threshold and an unpaired device not recognized by the processor, immobilize an ignition system.

3. The system of claim 2, wherein the preconfigured restriction limit is at least one of a selected time period and a selected day of a week via the user interface.

4. The system of claim 1, wherein the processor is further configured to, in response to the device being paired, prompt the occupant to define one or more preconfigured restriction limits for the device.

5. The system of claim 4, wherein the one or more preconfigured restriction limits are a first time period for the paired device to enable an ignition system and a second time period for the paired device to immobilize the ignition system.

6. The system of claim 1, wherein the processor is further configured to, in response to the occupant selecting a valet mode via the user interface, authorize the vehicle start request to enable an ignition system without the device.

7. The system of claim 1, wherein the vehicle key is associated with a vehicle and transmits a wireless signal to an ignition system to enable the vehicle start request.

8. The system of claim 7, wherein the wireless signal includes a rolling count encrypted code that is associated with the ignition system.

9. The system of claim 1, wherein the vehicle key is at least one of a key blade, a key fob, and an integrated key blade and fob associated with the processor.

10. A driver authorization method comprising:
receiving, via a vehicle processor, a request to start a powertrain based on a recognized key;
searching for a previously paired mobile device based on the request to start the powertrain;
if the previously paired mobile device is detected, enabling the powertrain; and
if the previously paired mobile device is associated with a predefined restriction by the vehicle processor, immobilizing the powertrain.

11. The method of claim 10, further comprising, in response to a detected device that is not paired with the vehicle processor, prompting an occupant via a user interface to pair the detected device based on a predefined password.

12. The method of claim 11, further comprising, in response to pairing the detected device, correlating a pre-approved setting with the detected device for authorizing an ignition system to start the powertrain when the key and the detected device are identified by the vehicle processor.

13. The method of claim 10, further comprising, in response to at least one of the previously paired mobile device having a preconfigured restriction limit and a non-paired device detected by the vehicle processor, immobilizing the powertrain.

14. The method of claim 13, wherein the preconfigured restriction limit is at least one of a selected time period setting and a selected day of a week setting.

15. The method of claim 14, further comprising prompting an occupant to define the preconfigured restriction limit for the previously paired device via a user interface screen.

16. The method of claim 10, further comprising,
in response to an occupant entering a predefined password via a user interface screen, prompting one or more driver authorization configurations, and
selecting a valet mode via the user interface screen based on the one or more driver authorization configurations, the valet mode enabling the powertrain without the previously paired device being present.

17. A computer-program product embodied in a non-transitory computer readable medium having stored instructions for programming a processor, comprising instructions for:
prompting an occupant via a user interface to pair a mobile device based on a predefined password; and
associating the mobile device with a start-approval setting to implement a vehicle start request by enabling a powertrain when a vehicle key and the mobile device having the start-approval setting are detected by the processor.

18. The computer-program product of claim 17, wherein the non-transitory computer readable medium further comprises instructions for, in response to at least one of an unpaired device and the paired mobile device having a preconfigured restriction limit, immobilizing the vehicle via the powertrain.

19. The computer program product of claim 18, wherein the preconfigured restriction limit is at least one of a time period and a day of a week.

20. The computer program product of claim 17, wherein the non-transitory computer readable medium further comprises instructions for, in response to an occupant entering a predefined password via the user interface, prompting one or more driver authorization configurations for the mobile device, and
selecting a valet mode via the user interface based on the one or more driver authorization configurations, the valet mode enabling the vehicle without the previously paired device being present.
